(19) United States
(12) Patent Application Publication
(10) Pub. No.: US 2018/0322974 A1
(43) Pub. Date: Nov. 8, 2018

(54) Compositions for Nuclear Reactions and for Fuel

(71) Applicant: Gene Kidman, Taylorsville, UT (US)

(72) Inventor: Gene Kidman, Taylorsville, UT (US)

(21) Appl. No.: 15/584,358

(22) Filed: May 2, 2017

(51) Int. Cl. G21G 4/02; G21G 5/00; G21G 7/00; G21C 3/56

(52) U.S. Cl. CPC G21G 4/02; G21G 5/00; G21B 1/01; G21C 3/56; G21G 7/00

(57) ABSTRACT

In accordance with one embodiment, lower energy photons are combined into a higher energy photon, a phat, by a shift in equilibrium from plasma toward condensing atoms. Phats are an ingredient for new compositions of matter and for nuclear reactions. Many of these compositions of matter are between a chemical and a nuclear scale. A self-assembled reactor is described at this scale. Also, fuels are produced that are high energy activated compositions of matter. Some activated compositions of matter can cause various nuclear reactions. A sequence is described for generalized chemical/nuclear steps. The nuclear reactions which occur include: photodisintegration, neutron absorption, accelerated nuclear decay of radioactive isotopes, and fusion of various combinations of elements.

### NUCLEAR FUSION PRIOR PATENT ART

Increasing demand for energy has increased the need for energy production. Energy is needed for the future growth and stability of our human population. We don't just need more available energy but energy at a cost that will allow development. We will need to develop more habitable earth surfaces, earth oceans and eventually space. Further, we need to balance the exploitation of energy resources with the risk to development of habitable resources. Solar and other naturally renewable energy sources provide only a small fraction of marketable energy. Exploitation of hydrocarbons has changed the environment and further exploitation of hydrocarbons poses a significant risk of causing a global catastrophe. Fission based plants have large safety requirements and cannot be made safe against all natural disasters. Nuclear fusion has a long history of promise but has yet to deliver on that promise.

Various nuclear fusion reactors have been classified and analyzed by John D Lawson. The Lawson criterion defines a minimum “triple product” of density, confinement time and plasma temperature needed for a conventional fusion reactor to reach ignition. Although there are many nuclear fusion reactions, most apply the Lawson criterion to combine two light nuclei. The failure to sustain the Lawson criterion has so far prevented delivery of the promise of abundant and cost efficient energy to prevent a global catastrophe. Although refinement of toroidal reactor design may yet allow a reaction to provide net power production, costs of such reactors are very large. Various approaches have been pursued to achieve the Lawson criterion on a smaller scale. Examples of these approaches are the use of cavitations in a deuterated liquid, (WO 2002097823 A1) and laser confinement of deuterated solid, (U.S. Pat. No. 4,650,630). Further, new designs have also emerged, for example US20140247913, which differ from a toroidal reactor. Still, there is a need for other approaches to nuclear fusion energy with lower costs of reactors.

Cost can be significantly reduced if fusion can be obtained without the requirement of reaching the Lawson criterion. There are several patents which propose that such a route to fusion is possible. The most significant group of these patents often refers to low energy nuclear reactions (LENR). Another approach applies a temperature intermediate between the Lawson criterion and LENR. Often LENR methods involve making metal hydride with hydrogen isotopes. Examples of patents using metal hydrides are: US20130044847, US2011/0005506, and US 20120164063 A1. Summaries of these efforts teach that nuclear active environments (NAE) are the source of fusion. Miley provides direct evidence of NAE [1]. These approaches need to produce a sufficient number of NAEs to become commercially practical. Still another method employs a glow discharge. An example is patent US 20090096380 A1. Still another method uses transient cavitation bubbles [2]. Several authors [3, 4, 5] have reported accelerated nuclear decay with nuclear reactions. Brown [6] has stimulated radioactive decay by treating the target nucleus with gamma photons, (US 20020169351 A1). The treatment causes an excitation of a giant dipole resonance of the target nucleus. LENR has remained at the research stage of development. LENR methods need to define chemical or nuclear steps, to provide stoichiometry of reactions and to define useful compositions of matter. Once these needs are met, LENR could gain broader acceptance as a realizable source of inexpensive, reliable energy. An intermediate temperature approach appears more promising.

Pharis Williams proposed that fusion could occur below the Lawson criterion if magnetic fields of projectile and target hydrogen atoms could be aligned. US patent 2012/0033775 A1 express this same idea in its summary as follows: “The electron clouds of the atoms are deformed into a toroidal shape by a magnetic field of the electric arc, thereby exposing the nuclei of both atoms.” Williams and Santilli expect an effect based on a macro magnetic field, not a catalytic (or a molecular) effect. Although Santilli proposes that his process generates a new state for the elements, he claims the use of a macro magnetic field and a trigger in his fusion process. The concept of a composition of matter that causes nuclear reactions is not anticipated.

Santilli proposes his theory while reporting his investigation of a method used to create gaseous fuels [6]. Some patents where an electric arc is used to produce chemical fuel or where an electric arc is used in a LENR design are: U.S. Pat. No. 5,069,765A, U.S. Pat. No. 5,159,900, U.S. Pat. No. 5,435,274, U.S. Pat. No. 8,129,656 B2, and EP 0393465 A2.

A molecular or catalytic description has advantages over a macro based description of a process, since the latter may be just one means of producing the true motive means for fusion. A molecular or catalytic description is needed to define information such as chemical/nuclear steps, stoichiometry of reactions and useful compositions of matter. With such detailed information, objectives may be chosen, equipment designed and outputs optimized. A description that will provide an engineering basis for nuclear fusion below the Lawson criterion at the molecular level is a significant advance in the state of the art.

There is much prior art that does not describe the novel aspects of this disclosure. However, many observations of the prior art will make more sense in light of the teachings of this disclosure.

Further Review of Prior Art: Research Roots of this Disclosure

### Imagining Catalyzed Nuclear Reactions.

Not only do microorganisms recycle organics and accelerate weathering but many authors claim that biological transformations make essential elements from other elements [3]. If the claims are true then catalyzed nuclear reactions/biological transformations occur. Catalyzed nuclear reaction can open new frontiers to human colonization by providing both better uses of earth's resources and direly needed energy.

Validation of these claims requires that the means of determining the elements involved be highly sophisticated, very specific and very reliable. One can see evidence of stoichiometry of a microbial catalyzed nuclear reaction in reports of Vysotskii and Kornilova [4]. Addition of deuterium to ₂₅Mn⁵⁵ to form ₂₆Fe⁵⁷ is thermodynamically possible and it fits the disappearance of reactants and appearance of product.

Many scientists would agree that catalyzed elemental transformation may have occurred if more verification was provided. However, only crude methods to produce and use any such catalysts are available. More skeptical scientists express a critical question. How does a microbe access energies thousands of times higher than that of typical chemical energy levels [7]? A high energy particle or at least a superphoton is needed in order to meet known energy requirements to bridge the coulomb barrier.

### Combining Photons to a Superphoton

Recent progress has been made in combining photons in a boson condensate by having the photons “cooled” with a dye [9]. The photons are reflected between parallel mirrors and pass through the dye in a gaseous state. Photons are absorbed and emitted from the dye. An analogy is made as follows: when identical particles of mass are cooled to same temperature, they condense. So, it is supposed that any small differences in the photons are eliminated by repeated absorption and emission from the dye. Thus photons gain identical relative mass. Further, since their kinetic energy is the same as their relative mass, they have the same temperature and can therefore condense to a “superphoton”. Are there easier ways to get superphotons?

Most scientists are taught that the maximum energy of the light from ionizing an atom is expected when the electron falls from infinity to the ground state, the ionization energy. Pharis Williams has reported that higher energy photons are also formed. To find these so called “phat photons” or “phats”, one has just to look for their spectra in the data already reported [10]. Phat photons occur at specific energies. Equation 1 is an equation to describe those energies and is as follows:

ε=N²hν. Equation 1: energies of phat photons.

Curiously, an equation identical to equation 1 appears in a Blacklight Power report [11]. There is a significant difference in the use of the above equation between Blacklight Power and Pharis Williams. Williams predicts high energy photons with no exotic chemistry and Blacklight Power predicts high energy photons by condensing hydrogen to fractional states below the ground state. Blacklight Power's model for their process is not nuclear. Perhaps it should be.

One might also look for phat photons to be generated during laser initiation of nuclear reactions. These nuclear reactions are discussed by Simakin and Shafeev [4]. They indicate that “It is believed that thermal neutrons needed for this transmutation are released from deuterium.” Photodisintegration of deuterium to a proton and a neutron uses a minimum of a 2.26 MeV photon.

In summary, because of a requirement for a high energy particle and no theory to meet that requirement, biological nuclear reactions seem unlikely. Yet stoichiometry data suggest it does happen. Likewise a laser should only have photons with insufficient energy for photodisintegration of deuterium. Yet, without Lawson criteria confinement, a laser can initiate a nuclear reaction. Both cases need a high energy particle, like a phat photon. Phats provide a missing link in both cases. No prior literature describes phats in the context of any nuclear reaction. Neither has Blacklight Power proposed a connection between equation 1 and a route to energy production based on phat photons. So, the use of phat photons for nuclear reactions has not been anticipated; nor have any compositions of matter that store, concentrate or confine phats been anticipated.

### REFERENCES

1. G. H. Miley, H. Flora, and X. Yang. Condensed Matter “Cluster” Reactions in LENRs. in ICCF-14 International Conference on Condensed Matter Nuclear Science. 2008. Washington, D.C.
2. Stringham, R., et al. Predictable and Reproducible Heat. in The Seventh International Conference on Cold Fusion. 1998. Vancouver, Canada: ENECO, Inc., Salt Lake City, Utah
3. J. Biberian, Biological Transmutations: Historical Perspective, J. Condensed Matter Nucl. Sci. 7 (2012) 11-25
4. V. I. Vysotskii and A. A. Kornilova, Nuclear Transmutation of Stable and Radioactive Isotopes In Biological Systems, Pentagon Press, New Delhi, 2010.
5. A. V. Simakin and G. A. Shafeev, Initiation of Nuclear Reactions Under Laser Irradiation of Au Nanoparticles in the Presence of Thorium Aqua-ions, http://arxiv.org/ftp/arxiv/papers/0906/0906.4268.pdf
6. Paul M Brown, Transmutation of Nuclear Waste Products Using Giant Dipole Resonant Gamma Rays, 1999, Infinite Energy, vol 4, page 23, 63
7. R. M. Santilli, AquaFuel, an Example of the Emerging New Energies and the New Methods for Their Scientific Study, arXiv:physics/9805031
8. See Mainstream Perspective in http://en.wikipedia.org/wiki/Biological_transmutation
9. See “German physicists create a ‘super-photon’.” Phys.org. 24 Nov. 2010. http://phys.org/news/2010-11-german-physicists-super-photon.html.
10. P. Williams, Phat Photons, http://www.physicsandbeyond.com/pdf/Phat%20Photons.pdf
11. R. L. Mills, J. Lotoski, H2O-Based Solid Fuel Power Source Based on the Catalysis of H by HOH Catalyst, http://www.blacklightpower.com/wp-content/uploads/papers/SunCellPaper.pdf
12. See Casmir Effect in http://en.wikipedia.org/wiki/Casimir_effect
13. R. N. Mohapatra, Weak Interactions: From Current-Current to Standard Model and Beyond, http://arxiv.org/pdf/1210.5258v1.pdf

### SUMMARY

In accordance with one embodiment, a reactant mixture consists of atoms of hydrogen and/or of suitable substitutes for hydrogen atoms and, if desired, other target atoms. The reactant mixture flows into a first region with a means of ionization. The ionization means is sufficient to create electrons and ions. The means of ionization is also a means to provide an amount of light sufficient to create quantum states between electrons and ions. Further, a flow time through the first region is for a time period sufficient to energize these quantum states. The flow out of the first region comprises a means to shift mass equilibrium toward a condensation of atoms. The shift produces transverse and non-transverse waves of sufficient energy to activate atoms for nuclear reactions.

Per teachings of this specification, one kind of these waves are boson condensates of lower energy transverse waves and conform to a prior art description of phat photons. Phats convert to non-transverse waves. A new teaching of this specification is that these non-transverse waves are w-waves. A w-wave is a modification of a W particle to a wave form. The w-waves model teaches about chemical/nuclear properties of w-wave activated atoms. These properties derive from the law of relativity and descriptions governing weak transformations. W-waves can obtain their energy from phats.

Thus phats and w-wave activated atoms become ingredients for nuclear reactions. There is a general sequence of activations and reactions. First, lower energy photons combine into higher energy photons, phats. Second, the phats are absorbed as non-transverse waves by some atoms of the reactant mixture thereby producing transition states between chemical states and nuclear states. These transitions states are pre-nuclear forms of a w-wave. Third, the pre-nuclear states have dipoles which cause attraction to each other and to ions of target atoms (if added). Clusters form of w-wave activated atoms. Cluster formation is driven by attraction and by diffusion or convective mass transfer. Fourth, the cluster acts as a nano-sized nuclear reactor where component atoms of the cluster combine in de novo synthesis of elements or in new chemical/nuclear compositions.

Phat photons and w-wave activated atoms can be used in various nuclear reaction schemes. One skilled in the art can produce several outcomes of this general sequence of activations and reactions. The nuclear reactions which occur include: photodisintegration, neutron absorption, accelerated nuclear decay of radioactive isotopes and fusion of various combinations of elements. Some chemical/nuclear compositions have value as fuels.

### FIGURES AND TABLES

FIG. 1 is a diagram of energy levels between ionized hydrogen isotopes and electrons in a plasma state.

FIG. 2 is a representation of a w-wave.

FIG. 3 is a list of linked reactions that can produce a neutron.

FIG. 4 is a flowchart of an embodiment.

FIG. 5 is a representation of a self assembled nano-scale reactor.

FIG. 6 is a comparison of de novo transformations which sum to a main reaction and a side reaction for an example of an embodiment A.

Table 1 is an analysis of before and after reaction data for an example of an embodiment A.

Table 2 is an accounting for chemical and nuclear reactions for an example of an embodiment A.

Table 3 is a calculation of stoichiometry for a main reaction for an example of an embodiment A.

Table 4 is a calculation of stoichiometry for a side reaction for an example of an embodiment A.

Table 5 is a comparison to balance components in a main reaction for an example of an embodiment A.

Table 6 is a comparison to balance components in a side reaction for an example of an embodiment A.

Table 7 is a calculation of production of energy on a basis of an expectation of all mass loss becoming energy.

Table 8 is an accounting for chemical and nuclear reactions for an example of another embodiment B part A.

Table 9 is an accounting for chemical and nuclear reactions for an example of another embodiment B part B.

Table 10 is the calculated energy yield of AquaFuel components based on chemical composition.

Table 11 is a list of calculated values for AquaFuel comparisons.

Table 12 is a list of elements which elements have at least one ionization energy value at the same energy value as one of the phats of hydrogen ionization.

Table 13 is a list of heat production at various temperatures of Kidman reaction fuel produced from water.

### DESCRIPTION OF AN EMBODIMENT

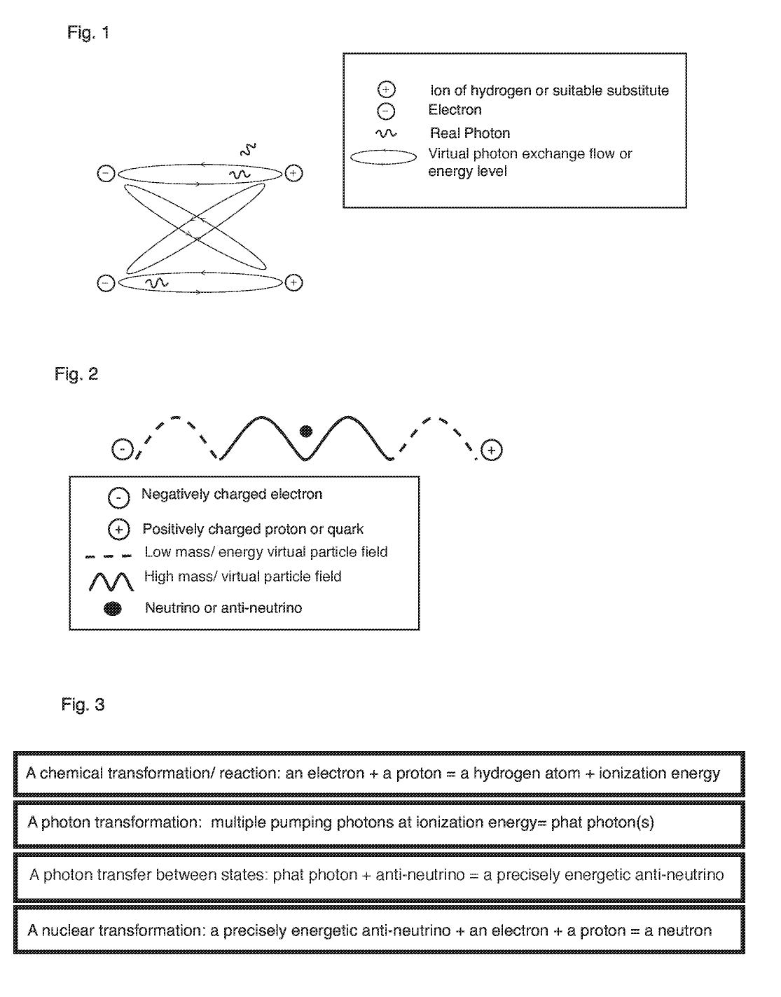

Pharis Williams has proposed the existence of phat photons. FIG. 1 illustrates how photons link between ions and electrons to form energy levels. These energy levels can fill with photons. When ions and electrons condense simultaneously, these energies can combine to superphotons or phat photons. Photons are transverse waves. Photons can convert to non-transverse waves. For example, in the photoelectron effect, light is absorbed by a metal, and then the metal ejects an electron. When a phat photon converts to a non-transverse wave within an atom, the energy of the photon is preserved in a new wave form, a w-wave. FIG. 2 illustrates a w-wave. A w-wave is an activated state. That activated state can decay and release a phat photon and an atom in a ground state. A w-wave has an electric dipole. A w-wave is possible because neutron decay is a reversible reaction. FIG. 3 lists linked reactions leading to production of neutrons. One kind of w-wave is a transition state between a chemical activity and a nuclear activity. A w-wave can absorb energy from a photon which is a common chemical activity. A w-wave can transform a proton to a neutron which is a nuclear activity. The above relations can be combined via a method to produce de novo chemical/nuclear compositions. These new chemical/nuclear compositions are activated chemical/nuclear compositions and have value as fuel and have value as means to produce nuclear reactions.

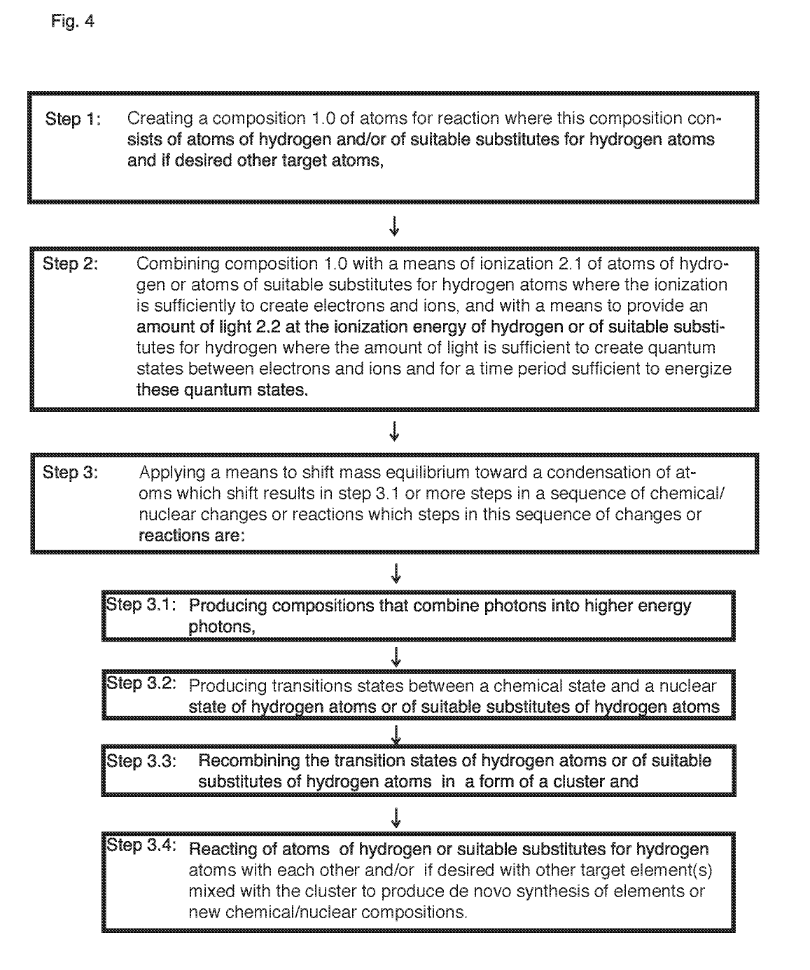

A flowchart for an embodiment of a process to produce a chemical/nuclear composition is shown in FIG. 4. The chemical/nuclear compositions derive fuel value from nuclear reactions, produce nuclear reactions and produce elements de novo from nuclear reactions.

This method consists of:

Step 1: creating a composition 1.0 of atoms for reaction where this composition consists of atoms of hydrogen and/or of suitable substitutes for hydrogen atoms and, if desired, other target atoms,

Step 2: combining composition 1.0 with a means of ionization 2.1 of atoms of hydrogen or atoms of suitable substitutes for hydrogen atoms where the ionization is sufficient to create electrons and ions, and with a means to provide an amount of light 2.2 at the ionization energy of hydrogen or of suitable substitutes for hydrogen where the amount of light is sufficient to create quantum states between electrons and ions and for a time period sufficient to energize these quantum states.

Step 3: applying a means to shift mass equilibrium toward a condensation of atoms which shift results in step 3.1 and leads to more steps in a sequence of chemical/nuclear changes or reactions which steps in this sequence of changes or reactions are:
step 3.1; producing compositions that combine photons into higher energy photons,
step 3.2; producing transition states between chemical states and nuclear states of hydrogen atoms or of suitable substitutes,
step 3.3; combining the transition states of hydrogen atoms or of suitable substitutes in a form of a cluster and
step 3.4; reacting atoms of hydrogen or suitable substitutes for hydrogen atoms with each other and/or if desired with other target element(s) mixed with the cluster to produce de novo synthesis of elements or new chemical/nuclear compositions.

### Operation of an Embodiment

### Visualizing Step 3.1 of the Flowchart.

The following thought experiment refers to FIG. 1. FIG. 1 is a diagram of energy levels between ionized hydrogen isotopes. Imagine hydrogen ionization with equilibrium of absorption and emission of photons. Via quantum electrodynamics (QED) one imagines virtual photon exchanges between electrons and hydrogen ions. These exchanges define energies and chemical states. Each instance of photon equilibrium consists of a pair where one member of the pair is an electron and the other member is a proton. If one pair is involved, N is one. However, suppose that a free electron senses via quantum electrodynamics indistinguishable possibilities for condensation to a hydrogen atom with either of two free protons. Further, with no prejudice for a proton or an electron, one expands the possibilities to complete cycles of virtual exchange of light: are two pairs and 2 squared possibilities of virtual exchange of light. If repeated virtual exchange creates the sensing for (QED), then it also creates quantum energy vacancies or energy levels. Imagine this example: the Casmir effect [12] with electrons and protons acting as the parallel plates and specific quanta getting trapped. Since there are four possibilities, all four vacancies can be filled. These four trapped quanta can condense to a single quantum. For some unknown reason the boson condensate occurs if all four vacancies fill and combine. That is to say that there is no report of partial combinations. The energy of the boson condensate is limited by the number of pairs in equilibrium, N. Equation 1 was listed earlier and is repeated below for comparison to the above logic:

ε=N²hν.

For example, let's say one wants a minimum of a 2.26 MeV phat photon for photodisintegration of deuterium to a proton and a neutron. There are at least 408 electron-proton pairs in equilibrium. This result can be calculated from equation 1 where 13.6 eV is the pumping photon energy, (=hν), the hydrogen ionization energy. Our thought experiment envisions a means to pump energy from low energy photons to high energy photons. The low energy photons are produced from condensing electrons and ions to individual conventional quantum states. The high energy photons are produced from condensation of energy of states within a plasma state. These states within the plasma are between electrons and protons connected by photons but can condense simultaneously to conventional quantum states or produce an alternative excited state (see step 3.2).

### Visualizing Step 3.2 of the Flowchart as a Pre-Nuclear State or Chemical State.

The foundation of catalysis is transition states. Chemical transition states combine excited quantum states of atoms in transition from reactant to product. A transition state for nuclear catalysis combines excited chemical states with states of particle affected by weak or strong nuclear forces. This transition state or states is/are linked in some way to a state with sufficient energy for a reaction by the weak or strong force. All the states involved in the bridge to a nuclear state from a chemical state are part of a virtual transition state. Since the nuclear reaction has not yet occurred at the moment of transition, any transition state(s) are pre-nuclear states.

The bridge between a nuclear reaction and a chemical reaction is linkages. For example, a nuclear reaction and a chemical reaction are linked through reactants and by a chain of reactions and chains of energy exchange. Also note in this example that the chemical reactants are a subset of the nuclear reactants. The linked reactions are as below or see FIG. 3.

A nuclear transformation: a precisely energetic anti-neutrino+an electron+a proton=a neutron.

A chemical transformation/reaction: an electron+a proton=a hydrogen atom+ionization energy.

A photon transformation: multiple pumping photons at ionization energy=phat photon(s)

A photon transfer between states: phat photon+anti-neutrino=a precisely energetic anti-neutrino

As in the previous section, one imagines complete cycles of energy exchange as waves via the Casmir effect. Virtual exchange cycles correspond to excited quantum states. The same is true here. One of parallel plates is an electron and the other plate is a proton but with a new twist. The exchange of energy has trapped a neutrino and the wave between the plates is non-transverse. That is to say: the energy of quantum state corresponds to the kinetic energy of the trapped particle (or w-wave). A given for this example is that the trapped particle is an anti-neutrino and/or its anti-particle. Neutrino pairs are generated from the energy of an electromagnetic field between proton-electron pairs, (analogy is Hawking radiation) [12]. For our purpose we will not consider the fate of the unused neutrino or whether the neutrino is a Majorana fermion and therefore its own anti-particle [13].

The formation of a pre-nuclear state is envisioned as being a result of energy from the photon phats (these are formed in step 3.1). Phats are translated from a photon (a transverse wave) to a non-transverse wave. Each pre-nuclear state formed corresponds to an energy level N, since there are N corresponding transverse wave energy levels or phat photons. Here, the non-transverse wave is a particle in motion, for example an antineutrino.

### A Fitting of the Compositions of Matter for Step 3.2 to Equations and to Known Facts.

The lowest energy non-transverse wave is converted from a 13.6 eV photon and is in the N=1 state. The highest energy non-transverse wave that we need consider is precisely the energy used for a nuclear transformation, 0.7824260693 MeV. Such a photon has a real conversion of energy to mass to satisfy the above nuclear transformation equation. Since all these non-transverse energy levels are interconnected, one real reaction causes them all to exist. Since the non-transverse waves originate from phats, the non-transverse wave energy is approximately the energy of the corresponding phat. If one uses the energy 0.7824260693 MeV in equation 1 and solves for the energy level, the energy level is N=240. The fit can be determined to a high degree of precision by adjusting conversion efficiency of the 13.6 eV photons. For example 13.583785925 eV allows 0.7824260693 MeV to fit to N=240 to within 2.0E-5 eV. A fit to this degree of precision suggests that pre-neutron states of hydrogen likely exist. Therefore, this route to nuclear reactions is the creation of a neutron by combining the energy of a phat and an anti-neutrino to a proton and an electron as described in this section. Further, nuclear reactions occur when a neutron is absorbed by a target atom.

Visualizing Basic Nuclear Steps for Step 3.2 as w-Wave Behavior

A view here referred to as a w-wave behavior can help envision steps 3.1 through 3.4. Representation of a composition of matter with w-waves is a simple teaching tool. Alternative models are possible. FIG. 2 is a representation of a w-wave. The w-wave description is a modification of the standard model for neutron decay.

In the standard model neutron decay occurs in two steps.

Quark d=quark u+W

W=anti-neutrino+electron.

In the modified model, W is a wave and the wave has not condensed to a particle. The wave is an overall description of the energy of the system. A w-wave is a non-transverse wave between u quarks in the atom's nucleus and electrons. A non-transverse wave is a particle in motion. In this case, the particle is a neutrino or anti-neutrino, but we will call it an anti-neutrino. The course of the anti-neutrino is refracted by virtual particles. These virtual particles are created about the anti-neutrino from energy in the field between an electron and a u quark. This refraction creates an obligate path for the anti-neutrino and causes it to bounce between a u quark and an electron. The w-wave can convert to a W particle and standard model W particle transformations can occur at the electron or quark u. The electron remains bound and does not move in forbidden space but rather will tunnel from end to end of the w-wave. In between the ends, a w-wave is described as an anti-neutrino in motion. In describing the anti-neutrino in motion, the energy of the field between the u quark and the electron is the kinetic energy of the anti-neutrino. The kinetic energy of the anti-neutrino has a range of values rather than just the exact value of the energy for transition of a quark u to a quark d. These states do not have an obligate conversion of a w-wave to a real W particle. In the cases where there are not expectations for nuclear conversion, these states are given the name of pre-nuclear states when external to the nucleus. The behavior of a pre-nuclear state is predicted by relativistic effects on the anti-neutrino.

### A Second Fitting of the Compositions of Matter of Step 3.2 to Relativity Equations and to Known Facts.

Let's compare the anti-neutrino in the N=1 state to the anti-neutrino in the N=240 state with relativity. The equation for this comparison from relativity theory is as follows:

L/Lo=mo/m=Δto/Δt=Lorentz factor.

The subscripted state is the one that the wave is accelerated from by absorbing more energy as matter, m=mo+Δm. One can compare these states with an estimate for the apparent radius of the atom. Relativity acts in one dimension so the apparent radius is a length. The N=1 atom with the non-transverse wave has a less tightly bound electron than the hydrogen atom. So, a good starting value is approximately 1.5 times the Bohr radius, 80,000 fm=Lo. One guesses that the radius at N=240 is not far from the nuclear radius. The value for the nuclear radius is r=1.4 A^{1/3} where A is sum of the neutrons and protons of the nucleus. So for a neutron the apparent radius is 1.4 fm=L. The mass of the anti-neutrino (mo) is expected to be very small, so the anti-neutrino's mass at the N=240 state is almost all relative mass (m≈Δm). Thus one can use m=0.7824260693 MeV, a mass expressed as energy which is the amount of energy needed for the transformation of a proton, an anti-neutrino, and an electron to a neutron. From the equations above for relativity, one calculates mass at N=1 state to be 13.693 eV=mo. This is very satisfying, since the mass is very close to the energy of the excited state, the hydrogen ionization energy. The mass of N=1 state is mass of the neutrino plus the mass from energy from an absorbed photon. Using this energy and subtracting energy previously calculated for the N=1 photon, (the energy obtained by fitting the non-transverse energy levels), then (13.693-13.584)=0.109 eV is the anti-neutrino rest mass. The calculated anti-neutrino rest mass has a value in the range expected by astronomy. Again, the fit of the model to the facts is good and provides confidence that relativity theory supports the envisioned w-wave. Of course, the estimate of neutrino mass is an approximate. We can adjust the N=1 radius or N=240 radius to change the estimated rest mass of the anti-neutrino.

Behavior of w-Wave Activated Hydrogen Isotopes Based on Above Composition of Matter.

The behavior of pre-neutron states ranges from the behavior of a proton to the behavior of a neutron. Two neutron behaviors are: 1) a neutron's shield property toward the Coulomb barrier and 2) its decay time outside the nucleus. Both behaviors apply to pre-neutrons state as a function of relativity. Relativity tells us that the radius of the pre-nuclear state or length between positive and negative charges gets apparently smaller as the energy of the non-transverse wave increases. Also, relativity predicts that the pre-nuclear state gets more massive and has a longer decay time as the energy of the non-transverse wave increases. Since, the length of the dipole decreases as the energy of non-transverse wave increases, the charges on either end of the dipole are shielded by each other relative to other charges outside the dipole. The dipole length allows an apparent positive charge to vary from that of a proton to that of a neutron. The apparent charge can be represented as a product of an expected proton charge and a shielding factor. A shielding factor provides a means to calculate the energy used for fusion of a pre-nuclear state to a target atom caused by a collision. The dipole appears because the wave has a negatively charged electron on one end and a positively charged quark u on the other. However, later we will see that the non-transverse wave is likely not restricted to a path between a specific pair (electron and proton or u quark). The evidence for this is accelerated nuclear decay rates. Further, accelerated nuclear decay implies transfer of energy across the coulomb barrier. Energy of a pre-nuclear state is transferred to create a wave internal to the nucleus. The wave internal to the nucleus also has the form of a w-wave. Thus, atoms can be activated by w-waves.

Hydrogen ionization generates specific phat photons with corresponding pre-nuclear states. Without these pre-nuclear states to absorb energy, the energy of photons produced by hydrogen ionization disperses. Therefore, efficiency of energy coupling to nuclear reaction is much lower without pre-nuclear states and atoms activated by w-waves. Hence, a higher conversion efficiency of input energy to nuclear reaction energy is expected with pre-nuclear states and atoms activated by w-waves than if there were no way to focus light energy of a laser into an activation pathway for the target atoms.

Visualizing Step 3.3 and 3.4 as w-Wave Behavior

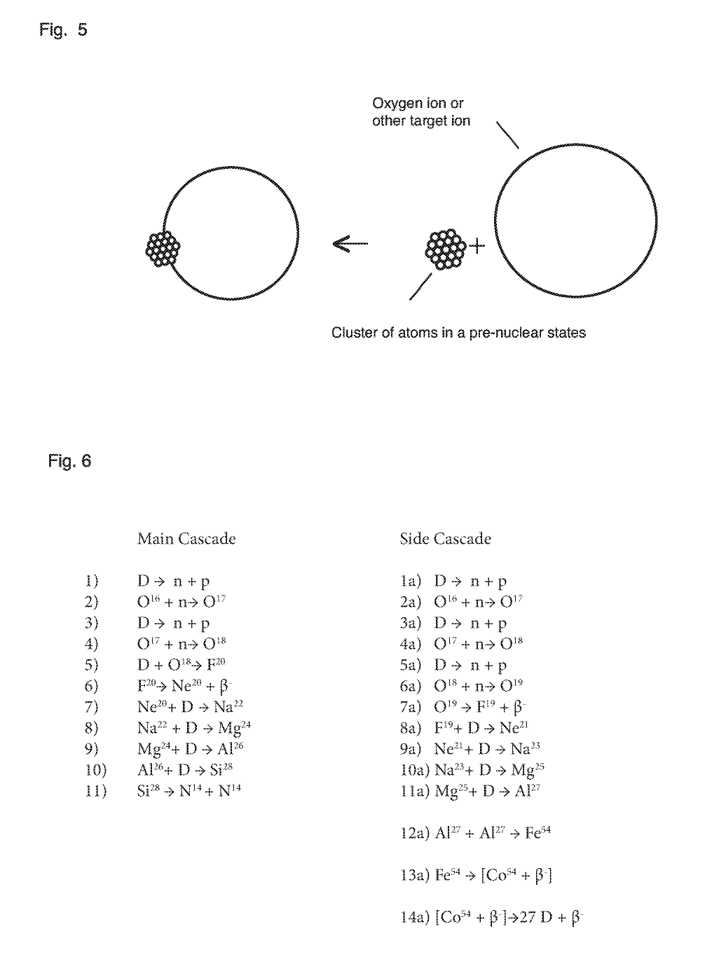

Dipoles attract to dipole via a dipole to dipole bond. The dipoles polarize local space. Thus these pre-nuclear states concentrate in clusters. A cluster is the chemical/nuclear composition of matter in step 3.3. A cluster accumulates energy locally. The accumulation of energy is due in part to time dilation which increases apparent decay times and in part to energy sharing between the non-transverse wave and other particles in motion within the w-wave affected nuclei. A cluster is a self assembled nano-sized nuclear reactor. FIG. 5 is a representation of a self-assembled nano-scale reactor. In FIG. 5 an ionized target atom is attracted to the polarized space charge of a cluster. So a target ion will become part of a cluster.

This nano-scale nuclear reactor can cause several kinds of nuclear reactions to atoms which atoms are added to the nano-scale reactor volume. A w-wave external to the nucleus can transfer into the nucleus and remain within the nucleus. W-waves internal to an atom's nucleus are described as a giant resonance of the nucleus. Therefore, w-waves can route photonic energy into and out of atomic nuclei thereby altering the rate of radioactive decay or thereby causing photodisintegration of certain elements. These w-wave states can shield charges thereby lowering the coulomb barrier and facilitating nuclear fusion. Later we will see that w-waves within a nucleus can lower the coulomb barrier from within the coulomb barrier.

Some of the Prior Art Observations which can be Interpreted as Resulting from the Behavior of the Above Compositions of Matter.

There are several suggestions that this w-wave model is correct. Because of the clustering behavior, nuclear reactions occur in nuclear active environments, referred to as NAE in the LENR literature. However, this nano-sized cluster may or may not remain at a specific location such as a chemical interface. Miley provides direct evidence of clusters [1] which the w-wave model predicts are pre-nuclear states drawn into a cluster by attraction of their dipoles and by exchange of w-waves. Blacklight Power has observed spectra of hydrogen derived chemicals [11]. This w-wave model for pre-nuclear states predicts the same spectral lines from a hydrogen derived composition matter but as a result of phat formation. This w-wave model predicts accelerated nuclear decay for w-wave affected atoms by excitation of giant resonance. Several authors [3, 4, 5] have reported accelerated nuclear decay. Brown [6] has reported gamma rays absorbed in the giant resonance will increase nuclear decay rates. The absorbed energy creates a more excited state which increases the decay rate. This w-wave model predicts giant resonance excitation with non-transverse (w-waves) rather than transverse waves (gamma rays).

### An Example of a Description of an Embodiment A.

Although the prior art has not anticipated the specifics of this disclosure, their teaching provide observations which support the w-wave model used to teach this disclosure. Therefore, using the teachings of this disclosure, data from prior art may be used to teach more specifics of a process to produce chemical/nuclear compositions. These compositions derive fuel value from nuclear reactions and produce nuclear reactions. Although lacking optimization, some data of Santilli's patent US 2012/0033775 A1 is very useful for this purpose.

Steps from the flowchart of FIG. 4 are present in the chemical conditions used in Santilli's patent to produce data in Santilli's FIG. 7 as follows.

For step 1: hydrogen isotopes and a target atom are present.

For step 2: direct current plasma provides a means of ionizing atoms of hydrogen producing electrons and ions, and a significant amount of light at the ionization energy of hydrogen.

For step 3: there is some natural circulation between the bulk gas and the gas in the plasma which is a means to shift equilibrium.

Power to the arc was supplied for two minutes which provided light intensity sufficiently long for step 2. Mass and energy transfer between the plasma and the bulk gas is sufficient to produce all of the sequence of chemical/nuclear changes from steps 3.1 to step 3.4.

### An Example of Operation of an Embodiment A.

Santilli's patent's FIG. 7 reports the composition of a gas mixture before and after the application of an electric arc. The data is provided on a volume basis. Under standard conditions of temperature and pressure a mole of any gas occupies 22. 4L. Further, gas retains the same mole % composition regardless of temperature and pressure or size of the sample. Further, for a known molar amount of gas, the before transmutation and after transmutation samples need to balance with the same total number of baryons; since baryons are conserved in transmutation. A baryon is a nucleon, (proton or neutron). The volume percentages are mole percentages. So, if 100 volume % of the sample before reaction has the same nucleon count as 100 volume % of the sample after reaction, then the two samples have the same mass basis. With the same mass base, we can calculate the change in mole % of the components of the reaction. The net reaction is the difference between the before reaction sample and after reaction sample which is calculated as shown in table 1. The term PPMV in table one is parts per million on a volume basis. We can also use stoichiometry to account for chemical changes between components.

Data from table 7 of Santilli's patent was used for analysis. The balance to account for chemical reaction is in table 2. The change in the mole percentage that is not a chemical change is due to nuclear transformation. Since the transformation also has stoichiometry, we can solve for the main nuclear reaction equation and also for a side nuclear reaction, provided that there are few (two or three) transmutation reactions. The calculation of stoichiometry is shown in tables 3 and 4.

A more precise balance can be achieved with some assumptions. First, that the after reaction sample has some nucleon excess compared to the before reaction sample to account for carbon from the electrodes which becomes carbon dioxide. Second, that unknown gases in after reaction sample are likely a pairing (bonding) of ions with dipoles of pre-nuclear states of deuterium. Since nitrogen, oxygen and deuterium are most of the composition before reaction, a close assignment of the unknown is to divide it as if it were composed of the same mole percentages of these gases as in the before reaction sample. The excess argon was treated as a combination of four deuterium atoms and two oxygen atoms. These assumptions reduce reactant and product possibilities to just nitrogen, oxygen, hydrogen and deuterium. In his claims Santilli indicates that any atom can fuse with any other atom. These assignments are not possible when any atom can fuse with any other atom. Therefore, this analysis is not expected per Santilli's claims.

Basing the stoichiometry on nitrogen, one finds that one oxygen atom and seven deuterium atoms produce two nitrogen atoms. The small error between the integer value in the balanced equation and the non-integer value calculated from the reaction balance suggest that the reaction equation is correct. It also follows that the assumptions are close to correct. Further, the balanced equation shows conservation of nucleons, another expected condition. The overall reaction appears to converts two neutrons to protons. Coincidentally, two hydrogen atoms are produced.

By solving for a side reaction, a more precise fit of the balanced equations to the reaction balance is obtained. The side reaction is two oxygen atoms producing six hydrogen atoms and thirteen deuterium atoms. This leaves a slight excess of deuterium; which matches the slight insufficiency of hydrogen. So some hydrogen was likely converted to deuterium. The main reaction occurs 100 times per 6 times the side reaction occurs. The balanced equations appear in tables 5 and 6.

These balanced equations provide a very good accounting for the reported analysis so the assumed composition of unknown masses was likely correct.

### Reaction Cascades

It is very fascinating that among all reactions one could imagine, the reactions that happen have oxygen as a target and that any evidence for any other reaction is nearly hidden. For example, a nearly hidden reaction is the tertiary reaction where hydrogen is converted to deuterium or the reaction which produces mass 3. Mass 3 was not quantitated. Mass 3 could be dipole-ion bonding between hydrogen and deuterium or it could be ₂He³. To understand fusion to oxygen, let's apply w-wave theory with reference to FIG. 5.

Reactions based on the transfer of energy by anti-neutrinos are the most probable means of starting a nuclear reaction for three reasons. First, an anti-neutrino is the smallest mass particle and therefore easiest to exchange between reactants. Second, an anti-neutrino is neutral so it is not repelled by the positive charges in the nucleus. Third, the probability of an anti-neutrino's path and its exchange is more certain as a w-wave. Without this interaction caused by a w-wave, the probability of any interaction of an anti-neutrino is too small to consider. But in this case, there is more than an anti-neutrino; there is a non-transverse wave. Non-transverse waves are likely not restricted to a path between a specific pair (electron and u quark). The evidence for this is accelerated nuclear decay rates. Further, a w-wave can be intra-nuclear. Given the energy sharing of w-waves between the nucleons of deuterium, the pre-nuclear states for deuterium are more stable than for the pre-nuclear states of hydrogen. The closer an electron or u quark is to the wave, the more likely that the w-wave wanders. For example one expects a neutron of deuterium that is in atom in pre-nuclear state to share more often in a w-wave than a neutron or proton in some neighboring atom because the neighboring atom is farther away. Therefore, deuterium is a better kinetic energy sink than hydrogen; that is, phat photons are more likely to be accumulated by deuterium than hydrogen.

The pre-nuclear atoms have dipoles which bond to other dipoles and ions (dipole to dipole bond or dipole to ion bond). The greater polarization of space is; the greater the bonding behavior. At sufficiently low temperatures, atoms in pre-nuclear states will form clusters. The clusters concentrate the energy of the w-waves. Dipoles with a shorter dipole length have the greater polarization of space and greater energy storage. Interestingly, this dipole relationship is consistent with the equation which expressed the energy of a capacitor. The higher energy dipoles become the core of the cluster. Since the w-waves can wander, they convert a cluster into a nuclear reactor with electro-magnetic based containment of reactants. W-wave sharing of energy with nucleons is strongest at the cluster core. However, a target atom attached to the cluster has its nucleons subjected to a high energy influx via w-waves originating from the cluster. In summary, the above description is a self assembled nano-sized nuclear reactor. FIG. 5 is an illustration of a self assembled nano-scale reactor.

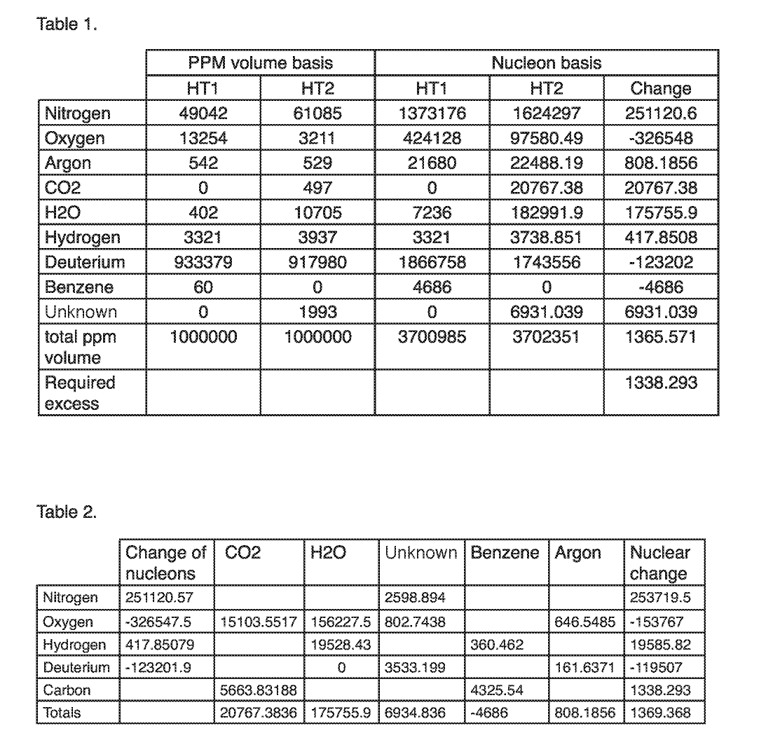

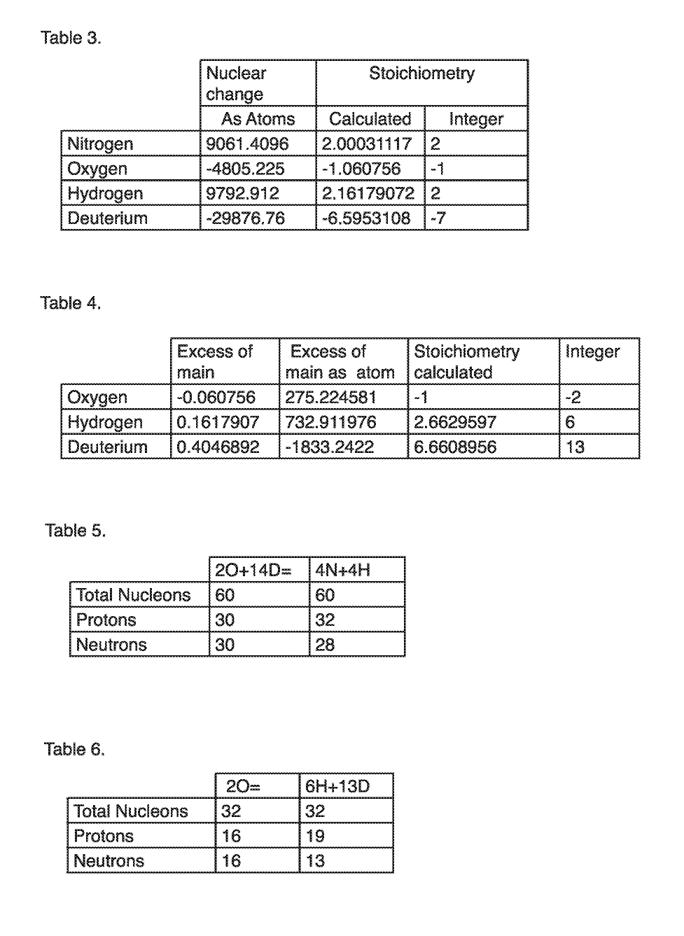

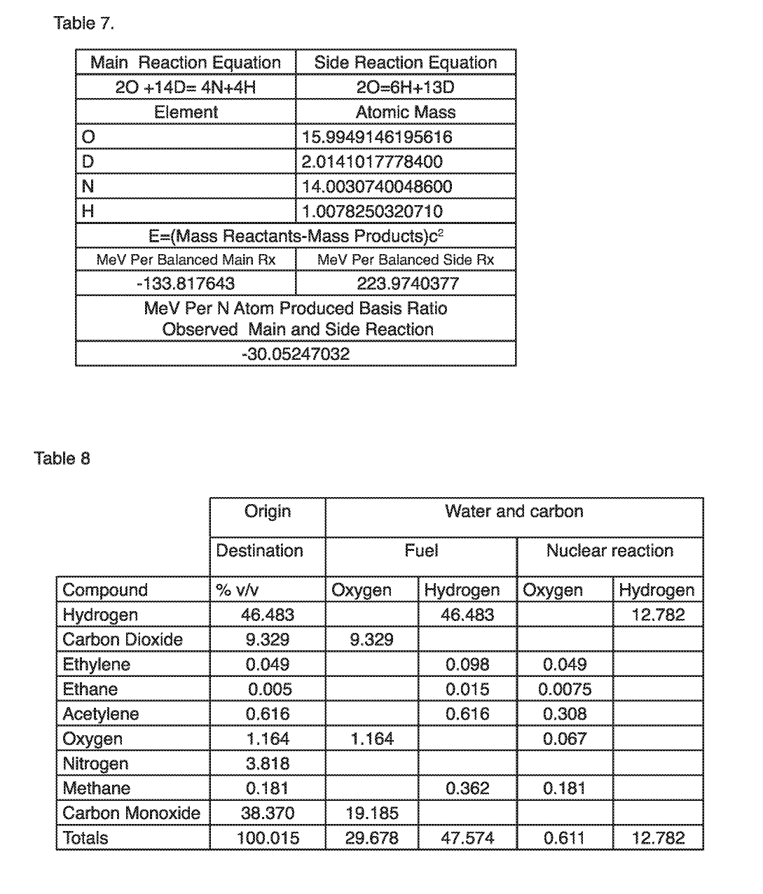

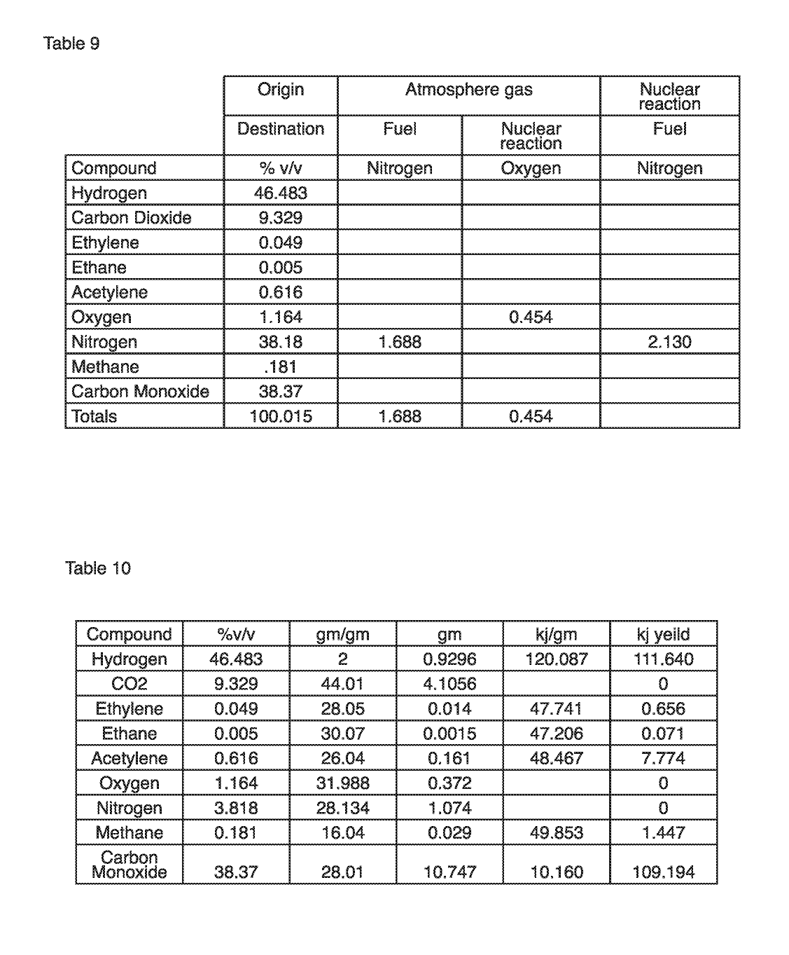

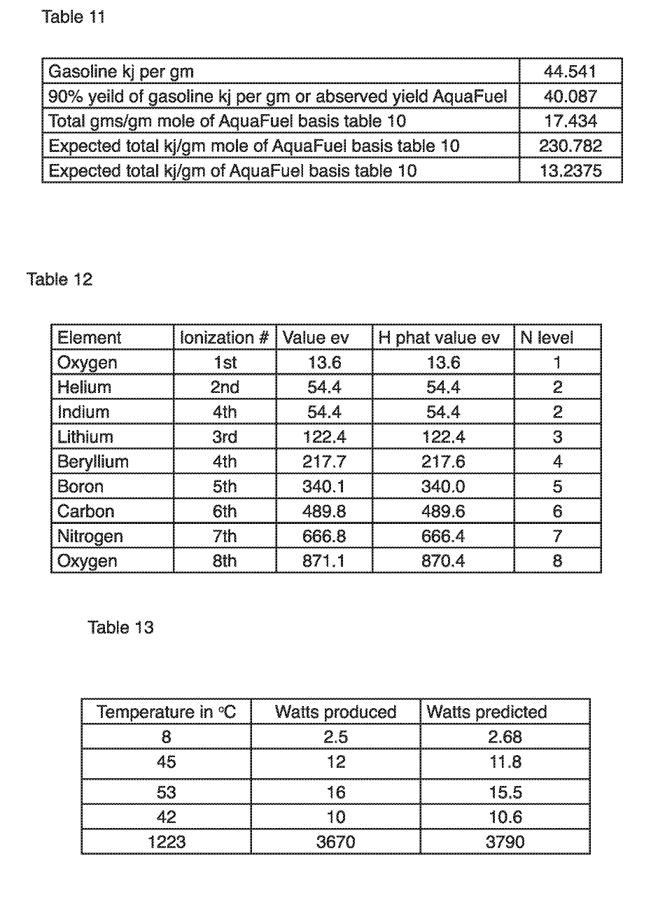

Oxygen is the prime target in this mixture of gas. It forms relatively stable ions in an electrical discharge especially by recombination with other chemicals. The most stable of these ions are the ionized forms of acids. The ionization energy of oxygen is lower than nitrogen and just above deuterium, so when a mixture of these gases is ionized, the relative concentration of ions are deuterium>oxygen>nitrogen. An ion-dipole attraction is stronger than a dipole-dipole attraction, so any stable ion can be attracted to a cluster of pre-neutron atoms. Based on the composition of the above reaction mixture one expects the dominant nuclear transformations to follow from excitation of the oxygen nucleus. The sequence of these transformations can be followed by reference to FIG. 6.

For cluster based fusion, energy concentrated to the target allows the target to create a photon of sufficient energy to photo-disintegrate a deuterium atom that is in a pre-neutron state. The resultant neutron is absorbed to oxygen but the proton is rejected by the coulomb barrier of the oxygen atom. Rejected protons are the origin of the hydrogen reaction product. The transformation reaction produces energy which causes a cascade of more reaction steps. The energy from each reaction is stored in the form of a giant resonance.

The next reaction in the cascade is also neutron absorption, and then the energy stored in the giant resonance of the target atom changes the dominant kinetic pathway. That change allows an atom in a pre-neutron state to pass through the coulomb barrier of the target atom. There are two effects in play: first, w-waves cause some deuterium to become more di-neutron like and second, the kinetic energy of the projectile is a push effect on the coulomb barrier which sums with a pull effect from the target. A greater giant resonance increases the pull effect.

The pull is like gravity induced by relativity. A dipole of the nucleus is predicted by relativity; a giant dipole resonance is due to non-transverse waves within the nucleus. Atoms rather than neutrons continue in the cascade until the target has so much energy that it fissions.

The reaction cascade for the main and a side reactions is shown in FIG. 6.

In general, a hydrogen atom in a pre-neutron state uses less kinetic energy (velocity) to penetrate the coulomb barrier when a higher amount of energy is stored in the pre-neutron state or when a higher amount of energy is stored in the activation of the giant resonance of the target atom. For example, a conventional projectile-target reaction has much push and little pull. The main chemical reaction above has less push and more pull. Further, the last steps of the side pathway can be explained with still more pull.

The side reaction cascade has an additional photodisintegration of deuterium before it begins to absorb deuterium as pre-neutron states. Whereas in the main reaction beta decay occurs at ₉F²⁰, in the side reaction, due to the extra neutron absorption, beta decay occurs at ₈O¹⁹. The main reaction sequence ends with fission of ₁₄Si²⁸ to produce nitrogen. The side reaction fuses two atoms of ₁₃Al²⁷, which fusion product becomes ₂₆Fe⁵⁴. The side reaction is endothermic in the last step whereas the main reaction is exothermic throughout. So, the side reaction absorbs energy which energy is supplied by the main reaction. The side reaction then ends by dissolution of the iron atom's nuclear core. The event which trips dissolution is a beta decay which produces an equal number of protons and neutrons. The fusion of excited ₁₃Al²⁷ states accounts for the odd number of deuterium produced from ₂₆Fe⁵⁴ (₂₇Co⁵⁴). The extra neutron absorption accounts for the number of hydrogen produced in the stoichiometry of the side reaction. Except for the last beta decay step in the side reaction, beta decays each correlates to the first unstable element in the reaction sequence. The aforementioned last beta decay triggers dissolution. This beta decay satisfies the number of neutrons converted to protons by the overall reaction balance of side reaction.

In both the main reaction and side reaction cascade, there is a point where giant dipole resonance energy is large enough that the target atom shifts the reaction pathway from photodisintegration to absorption of atoms in pre-nuclear states. This is the point where reaction is pulled from within the coulomb barrier rather than pushed by kinetic energy. The pull is so extreme in the side reaction that two ₁₃Al²⁷ atoms are drawn into fusion. Note that the ₁₄Si²⁸ atoms are not drawn into fusion in the main reaction. This difference is likely due to the difference in polarization of space by the giant dipole. W-wave interaction in the excited target accommodates the energy from fusion as evidenced by a cascade of fusions that occur before fission occurs. These atoms become a sink of energy. Energy sinks likely explain all of the following: the endothermic nature of the side reaction, the gravity like attraction that allows direct fusion of higher atomic weight atoms, and accumulation of energy sufficient for dissolution of the ₂₆Fe⁵⁴ (₂₇Co⁵⁴) to deuterium. When any atom is excited via non-transverse waves to a high enough energy density, the local gravity-like attractive force can overcome the Coulomb barrier. This gravity-like attraction is due to relativity and could provide a mechanism for hydrogen to hydrogen fusion or hydrogen to deuterium fusion. There is more on this subject in example of embodiment B.

### Energy Balance for Overall Nuclear Reactions in a Deuterium Plus Atmospheric Gas Mixture.

An energy balance is provided by Santilli. The basis is the conservative average increase of temperature of the steel container of 127° C. after application of a 40 kW arc for 2 minutes. He calculated the heat output as 7404 BTU and the power input as 4533 BTU. So, Santilli concluded that the reactions in the container produced 2871 BTU. Since the amount of combustion was very small, he concludes that the heat production must be from transformation. Based on his expectation, he concludes that the excess energy was from the synthesis of nitrogen from deuterium and carbon.

Santilli's equation for the reaction is based on his expectation. In contrast in this report, assumptions were made and verified by results. The reaction equation was derived from accepted principles of stoichiometry. It is a good conclusion that main reaction combines 14 atoms of deuterium with two atoms of oxygen to produce four atoms of hydrogen and four atoms of nitrogen. Further, the list of elementary reactions FIG. 6 can be summed to account for overall reaction which is the main reaction. From the balanced equations one calculate an atomic mass balance. Assuming the atoms produced have standard masses after reaction and all of the loss mass is converted to energy, one can predict the expected energy production from the combined exothermic and endothermic reactions as shown in table 7.

### Summary of Energy Kinetics, Sequence of Changes in Compositions of Matter, and Types of Nuclear Reactions

Energy flows from hydrogen ionization to phat photons. Further, corresponding to phat photons are pre-nuclear states. The pre-nuclear states are an energy sink for phats. Pre-nuclear states decay but relativity causes longer decay times than for a chemical state where photons are absorbed then emitted. The pre-nuclear states transfer non-transverse wave energy to nucleons in proportion to the number of u quarks accessible to w-wave activation. A target ion attracts the highest N pre-nuclear states with an ion-dipole interaction. The target nucleons become excited. Oxygen as an excited atom is an energy sink compared to deuterium in a pre-nuclear state, since oxygen has a higher density of u quarks. The excited oxygen atoms can initiate photo disintegration on contact with deuterium in a pre-nuclear state. Photo-disintegration of deuterium releases hydrogen and provides a neutron source which neutrons are absorbed by the target atom. At some point w-wave energy density in a target nucleus is high enough that w-waves draw a deuterium nucleus rather than just neutrons across the coulomb barrier. More fusions of deuterium follow. Whereas excited ₁₃Al²⁶ and deuterium fuse and the dipole stress leads to fission of ₁₄Si²⁸, excited ₁₂Mg²⁵ and deuterium fuse and charge shielding effect of the dipoles facilitates fusion of ₁₃Al²⁷. Finally, ₂₆Fe⁵⁴ (₂₇Co⁵⁴) becomes an energy sink, since ₂₆Fe⁵⁴ (₂₇Co⁵⁴) is not the final product of the side reaction. So, ₂₆Fe⁵⁴ (₂₇Co⁵⁴) continues to draw energy from the main reaction until a transformation of a neutron to a proton triggers fission or disintegration or dissolution of the ₂₆Fe⁵⁴ (₂₇Co⁵⁴) atom's nuclear core to deuterium atoms. The energy flows toward deeper energy sinks. Relativity is the driving factor in energy flow.

Since the mass balance shows the volume percentage of nitrogen produced, one can calculate the number of atoms transformed from the total moles of gas in the container before the reaction started. Therefore, one can predict the expected total energy production by the reaction. That value is about 95.6 million BTU for amount of material in Santilli's reactor. The actually heat produced was very much lower. Therefore, the expected energy was not produced as heat. It is a given that the energy was not ejected as energetic particles, since Santilli detected none. So, a reasonable conclusion is that missing energy is present as mass. The nuclear reaction occurs because of two types of energy sinks: deuterium atoms in a pre-nuclear state and target atoms activated by wandering w-waves. The expected energy is either in these energy sinks or distributed between them plus some undetected form of mass. The products of reaction have a form of stored energy and are fuels. Therefore, the overall reaction produces fuel.

### Another Example of Operation of an Embodiment B.

The effect of generating w-waves is allowing fusion to occur at criterion lower than Lawson's by creating dipoles within projectiles and targets. The prior example of an embodiment A suggests that even the fusion of hydrogen to hydrogen happens with use of an electric arc. The embodiment which follows confirms hydrogen to hydrogen fusion using an electric arc in water. An article written by Santilli [7] provides product composition data produced by an electric arc. The product gas, AquaFuel, is generated from the electrolysis products of water (oxygen and hydrogen) and reactions of these products and water with carbon. The carbon is provided by the electrodes.

The chemical/nuclear mass balance at the baryon level is shown in tables 8 and 9. The procedure is to account for the origin of the elements in fuel gas composition. One starts with the assumption that hydrogen fuses to deuterium and that deuterium is consumed by the stoichiometry described in the main reaction in the prior example of an embodiment A. Hence, all hydrogen is generated by the hydrolysis of water and is accounted for in the gas produced or by the hydrogen to hydrogen fusion to deuterium. All the deuterium is accounted for by the nuclear reaction to nitrogen. The oxygen is generated from hydrolysis of water or comes from atmospheric gas which contaminates the product fuel gas. So both oxygen and nitrogen are introduced to the fuel gas from the atmosphere at a ratio which is normal for atmospheric nitrogen and oxygen. Therefore whatever nitrogen is not accounted as originating from the atmosphere has a nuclear origin.

As described in the above paragraph, an accurate mass balance is obtained that shows that 2.13% of the nitrogen in AquaFuel originated from nuclear stoichiometry. Hence, the mass balance confirms the assumptions.

The combustion of AquaFuel produces energy and that energy output was compared to gasoline. The expected energy output from the chemicals in the fuel can be calculated from the chemical composition of the fuel gas. Calculated energy yield of AquaFuel components based on composition is shown in Table 10. List of values calculated for AquaFuel comparison is in Table 11. A nuclear fuel is part of AquaFuel. That conclusion is based on w-wave theory, on mass balance in table 8 and 9, and on the energy balance in tables 10 and 11. The basis data for this conclusion is the difference between the energy expectation based on chemical composition and the energy observed based on power and torque from combustion if the fuel had been gasoline. That energy is expected to have originated from the aforementioned nuclear fuel. Based on the chemical composition of AquaFuel, the calculated fuel value is 13.3 KJ of energy per gram which is about a third of the 44.5 KJ of energy per gram obtained based on power and torque from combustion. It clearly cannot be overlooked that a fuel which is not detected by chemical composition accounts for two thirds of the fuel value of AquaFuel. That a fuel is produced is clear, since the aforementioned nuclear reaction is separated in time and space from the combustion test.

An Example of Kinetic Equation to Show that Heat can be Produced from Products of the Kidman Reaction.

A general reaction where w-waves cause fusion of activated atoms in a nanoreactor environment is here called a Kidman Reaction. In one Kidman reaction a plasma state is created in connection with water. Natural cooling of that plasma converts deuterium to w-active atoms which condense to a nanoreactor. The nanoreactor causes a sequence of elemental fusion steps which produces w-active nitrogen. Also, the nanoreactor powers w-active based hydrogen to hydrogen fusion to sustain the supply of deuterium. The net reaction is 12H₂O→2N₂(w-active)+5O₂.

For this example, the fuels were produced by two methods. The first fuel is discussed in a report about AquaFuel by Santilli[7]. The second fuel is discussed by Stringham et al. [2] and is referred to as after heat since it is disassociated from the process which produces the fuel.

The first fuel is produced under water by an electric arc from a carbon rod. The gas from this reaction was then burned in an internal combustion engine. For data modeling purposes, the combustion engine is modeled as a constant temperature reactor. If one estimates the combustion temperature at 2110 C and the exhaust temperature is 336 C, then average temperature is 1223 C. The power value needed from the AquaFuel engine test data needs to be raw heat/sec not power recovery by the engine. It is estimated that power and torque was 90% of the same mass basis as gasoline. One can estimate a missing heat of combustion at engine reaction conditions to provide an equal amount of heat of combustion to 90% of the value of gasoline. That heat of combustion is for a mixture of the chemical fuel present by analysis and a non-chemical (not present by analysis) amount of nuclear produced fuel which mixture releases its heat of combustion. At steady state combustion, the chemical fuel and the non-chemical fuel are fed at a steady rate and produce a steady rate of heat or has constant power production. One can predict engine size based on the horsepower and torque from experimental data. A engine rated at 100 cc or about 3 hp is reasonable for the model. The fuel mix rate of 1 mole of fuel to 5 moles of air can be verified by mass and volume balance using carbon as the tie element. The nuclear produced fuel is based on 2.13% w-active nitrogen fed in 100 ml batches, an average compression to 33.3 ml and 1530 batches per second. Hydrogen concentration was based on analysis by NASA in Santilli's report.

The process to produce Stringham et al's fuel consists of first, exposing a metal foil to transient cavitation bubbles in D₂O, then the D₂O is replaced by H₂O and then the water/foil is exposed again to transient cavitation bubbles. After this process, the heat output is shown to be functional related to heat input of a joule heater. It does not depend on further exposure to transient cavitation bubbles. So like the nuclear derived fuel in Aquafuel, this heat does not have a chemical source or mechanical source. It is estimated that production of w-active nitrogen in the experiment of Stringham et al saturates the water. W-active nitrogen escapes as gas when the nanoreactors produce an amount that is in excess of maximum solubility. Therefore, the water contains a maximum of 40 ppm of w-active nitrogen in range of temperatures in the experiment. Water concentration is substituted for hydrogen concentration, the concentration is 55.5 M. The volume of the reactor is 15 ml. The engine test data rate was proportionally reduced to 15 ml to match the reactor volume of the experiment of Stringham et al.

Stringham et al show the fuel (after heat) data in their FIG. 1. The data in table one below is based on their FIG. 1 and a start temperature of 0 C for fuel from transient cavitation bubbles.

Stringham et al report a logarithmic relation of heat production to temperature of reaction. A plot of the data in table one confirms that relationship. Further, the nuclear part of fuel reaction in the engine test of AquaFuel fits to that same logarithmic relationship. The fitting of watts produced to exponential curve is done by solving for the activation energy. The kinetic equations for all the data is as follows.

Watts in 15 ml reactor volume=1.00 E10 Exp(−29716/RT)×[H]×[active N] R is 8.31 and the temperature is in degrees Kelvin.

As a reminder, a kj of energy produced for one second is 1000 watts. As further point of reference a gram of gasoline can produce 45.5 kj of energy. Particularly significant is that these are initial rates tests. The nuclear fuel moves thru the engine before it can release even 1/10,000th of its calculated potential.

The initial rates are based on w-active nitrogen. However, w-wave sharing causes matter than interacts with w-wave to cluster. The w-wave energy is dispersed system wide (within the cluster) but has greater density in atoms with higher nucleon content. The rate equation has a reaction dependence on hydrogen. W-waves states are much less stable in hydrogen than deuterium or than other atoms capable of sustaining w-waves. W-waves are shared between the proton and the neutron of deuterium. Hydrogen does not have a neutron, so its w-waves are less stable.

The difference in w-wave stability between hydrogen and deuterium is used in Stringham et al's experiment. Deuterium is a better fuel to make nanoreactors than hydrogen because energy is concentrated to nanoreactors faster due to greater stability of w-waves in deuterium than hydrogen. Once some nanoreactors are formed on the foil surface, the procedure takes advantage of stability in the opposite way. The w-waves created by nanoreactors become less stable as the ratio of hydrogen to deuterium in the nanoreactors increases.

One explanation for the rate equations is that a hydrogen containing molecule collides with a w-wave active cluster. That collision transfers energy to the bond between hydrogen and other atoms of the molecule. That bond with hydrogen is broken and reformed which releases the bond energy for that bond. The H—H bond energy is 94% of the H—O bond energy. The w-active nitrogen in the rate equation is actually a w-wave active cluster. Any component of the w-wave cluster could be the actual contact point. So the contact point could be a w-active nitrogen or any activated component in the cluster.

### CONCLUSIONS AND SCOPE

Activation by w-Waves Alters the Lawson Criterion.

Although the Lawson criterion defines a minimum “triple product” of density, confinement time and plasma temperature for nuclear fusion, it does so without consideration of the effects of w-waves on reactants. W-waves reduce the energy expectations to bridge the coulomb barrier. W-waves external to the atomic nucleus (pre-nuclear states) shield the projectile charge and w-waves within the atomic nucleus shield target charge. Reactants with w-waves are more reactive than reactants without w-waves. W-waves are produced by an embodiment described in the flowchart of FIG. 4 or by any process which includes those steps. Activation by w-waves is an improvement on composition of reactants for nuclear processes.

Expectation for Fuels which Store Energy in Atomic Nuclei.

When w-waves are within a nucleus, that atom has a giant dipole resonance. Atoms activated by gamma rays have a similar giant dipole resonance. The difference is: with excitation by w-waves, one may expect a greater possibility of non-transverse waves since the energy source is non-transverse. That is to say wave action (transverse or non-transverse) simulates like wave action (transverse or non-transverse). By nature, transverse waves couple transformation of one particle to another. Both strong and weak forces have transformation. Thus, non-transverse waves may also be two types corresponding to the strong and weak forces in the nucleus.

One may be justified in proposing that the majority of relative mass in a nucleus results from non-transverse wave action rather than just kinetic energy. Most of the binding in the nucleus is the strong force which changes color of quark but not quark type. Via the weak force, d and u quarks interchange, which exchange adds or subtracts an electron and anti-neutrino or an anti-electron and a neutrino. With a high concentration of w-waves, one may expect that the weak force is transferred mostly by w-waves.

Non-transverse wandering w-waves within the nucleus likely have electrons and anti-electrons at opposite poles with the wave in between. Two wave types couple to produce this effect. The electron, anti-neutrino and u quark are one wandering w-wave type and the anti-electron, neutrino and d quark are the other wandering w-wave type. The symmetry suggests that energy passes from one type of wandering w-wave to the other. Given that both electrons and anti-electrons are continuously generated by the dipole, then this type of giant dipole has a potential of emitting electrons and anti-electrons. By increasing the probability of beta emission, this type of giant dipole excitation accelerates decay of radioisotopes.

Also, stable nuclei are activated by wandering w-waves. Electrical balance allows stable nuclei to store a great amount of energy in a giant dipole resonance. A nucleus is like a giant drop of liquid with a more viscous core. Note that in the cascade of reactions of the side reaction above, the core of ₂₆Fe⁵⁴ (₂₇Co⁵⁴) dissolved and the liquid drop vaporized into smaller atoms, deuterium. This reaction is endothermic; more energy is used than is produced by the cascade of reactions. The energy for the side reaction comes from the exothermic main reaction; an expectation is that the energy is transferred from the main reaction to side reaction via w-waves.

### Relationship Between Fuels and a Nano-Sized Nuclear Reactor.

The Lawson criterion needs modification to account for the effects of w-waves. W-wave density, mass density and confinement are not independent parameters. Rather pre-nuclear states allow an unexpected mass density as a cluster and provide a means of containment as a cluster. A target ion uses its electric charge to attract the cluster. One envisions equilibrium in the exchange of w-waves driven by the principles of relativity. W-waves flow within a system defined by the cluster. Within a cluster, w-waves remain for longer times around regions with higher nucleon density. Thus, w-waves are attracted to the target ion's nucleons. Thus, the nucleon density of the target ion shifts w-wave density to itself and increases the magnitude of energy being exchanged. Given a sufficient transfer of w-waves to the target, it obtains sufficient energy to cause photodisintegration or to attract nucleons across the coulomb barrier. When fusion occurs, the energy of fusion is converted to w-waves in a giant dipole resonance of the fusion product. After fusion, w-waves may flow outward from the fusion product or toward the fusion product. The nucleons in pre-nuclear states draw w-waves from the giant dipole of a w-wave activated nuclear reaction product or a nuclear reaction product with sufficient nucleons and energy in the giant resonance acts as an endothermic sink for w-waves. The flow of w-waves depends on the composition of all the components of the system. In an example of an embodiment, the net reaction was exothermic; the net flow of w-waves is from nano-sized nuclear reactors to other atoms. These other atoms are activated by w-waves. The net result is production of chemical/nuclear compositions which have fuel value.

The scope includes nuclear derived fuels. For example, in the embodiment B which is based on AquaFuel, two thirds of fuel value was not accounted for by the chemical composition. There are several explanations for heat of reaction for AquaFuel, therefore the following explanation should not be considered restrictive for embodiment B. The heat may result from a mixture of conventional fusion with w-wave theory. Since a w-wave active atom can lower the coulomb barrier, then some fraction of atoms could have sufficiently high giant dipoles to fuse when the temperature is suddenly elevated. A lowering of the Lawson criterion allows some percentage of atoms to act as targets or projectiles for conventional fusion.

Although w-waves are suggested as a means to transfer energy between atoms, it should be understood that w-waves may create some other means of exchange of energy between atoms rather than being directly involved in such an exchange of energy. Other models are possible, so this model should not be considered restrictive.

### RAMIFICATIONS

### Ramifications of Methods

An embodiment is shown in the flowchart FIG. 4. The flowchart describes a sequence of chemical/nuclear changes or reactions.

These changes or reactions have dependences like other chemical reactions/processes. One expects dependence on the intensity and specific energies of light used since there are specific activations. One expects concentrations of chemicals and light intensity dependences to relate to reaction equations. One expects that concentrations of hydrogen isotopes or suitable substitutes of hydrogen atoms and of target atoms will affect outputs. One expects competing chemical reactions. For example in the description of operation of one embodiment A, the side reaction and the main reactions compete. Those skilled in the art use differences in reaction order, reactants, and concentrations of reactants and activation energies of competing reactions to engineer the reactions and provide more of a desired output. Further, the sequence progresses by flow. For example mass and energy transport can be focused on or flow through an active or reactive region. Within this first region energy sources fill the quantum states within a plasma state. Then condensation of phats and the production of pre-nuclear states increase with a shift of mass between regions or a shift of energy flow out of the region. Masses may flow from the first active region to a second region or energy may flow out of a first active region making of it a second state. This second region or state improves condensation of phats and the production of pre-nuclear states.

Mass and energy flow provides a means to maintain quantum states between electrons and ions for a desired time and is a means to then shift equilibrium such that the sequence of reactions occurs faster or more frequently than it occurs without these flows. Flow rates affect reaction outcomes. Time is needed to produce chemical/nuclear compositions.

These compositions act as an energy sink for high energy phats. This can occur by converting phats from transverse waves (photons) to non-transverse waves (energy storage). Pre-nuclear states are this energy storage of phat photons. These pre-nuclear states can self-assemble into nano-scale nuclear reactors given sufficient time, available space and a supply of pre-nuclear states. Self assembly uses mass transfer and can therefore be improved by mixing rather than depending on diffusion. The self assembly process concentrates activated chemical/nuclear states into a cluster formation.

There are advantages of one state of matter versus another state of matter related to viscosity. Low viscosity provides a greater availability of space in the reaction region and impedes transfer rates less than high viscosity. In this respect, a gas state has advantages over a liquid state and a liquid state has advantages over a solid state. One skilled in the design of mixing equipment will use mass and energy transfer to optimize the desired compositions, size of the self assembled nano-reactors and their number per unit time or per unit volume.

Any optimization depends on the desired output(s). So, optimization depends on desired product(s) or nuclear reaction(s). For example, one could desire to produce neutrons rather than new elements from reactions of a target atom. To achieve this desire, one could take advantage of a waveguide design.

For example, a waveguide is a receiver for electromagnetic energy. Dimensions within the waveguide determine the wavelength and therefore the energy of light in resonance in the waveguide. Therefore, one can calculate dimensions to accumulate high energy phats of the hydrogen ionization. The dimensions are at the nano-scale. If one accumulates both phats and hydrogen in pre-nuclear states with the waveguide, one expects a cluster of neutrons or neutron-like pre-nuclear states within the wave guide. The LENR literature refers to nuclear active environment. The author's calculations suggest that Miley's patents US20130044847 and US2011/0005506 make nuclear active environments which may be active to make neutrons within a waveguide. By designing materials to create higher densities of waveguides, one expects higher densities of nuclear active regions or pockets of neutron like matter. A waveguide has the advantage of accumulation of specific electromagnetic waves. Hydrogen is supplied by absorption to the material of construction of the waveguide. A shift in mass equilibrium occurs when the hydrogen concentration gradient changes. The space available for reaction is limited by the nano-scale dimensions of the waveguide. The accumulated pre-nuclear atoms can react with the material or media of the waveguide.

One may use the surrounding media in many ways. One can use it to improve outputs. For example one could reflect light into an active region, add energy or reactant through the media as needed and restrict the outflow of energy out of the active region by insulation. One could use surrounding media as shelter of the means of ionization from forces that quench the sequence of chemical/nuclear reactions before the sequence has reached a desired step. One could use surrounding media as an interface between steps in the sequence of chemical/nuclear reactions. In the case of transient cavitation bubbles, the change in speed of sound at the interface of metal and the water causes the plasma. In like manner, a laser irradiation of Au nanoparticles also is expected to produce plasma on the metal surface.

Media and the source of energy can be used to create an active region. For example, one may shape a flow pathway to concentrate the flow in a manner like a concentrating lens or using material properties or electromagnetic properties to achieve energy concentration. Sources for the energy flow include pressure, heat, sound, electrical induction, or light intensity. A laser can create an active region. Another means to concentrate energy flow is sonic disruption (cavitations). Transient plasma is expected between an electrically energized electrode and a reaction fluid in an electrochemical cell.

The use of electrochemical cell engineering is expected to be particularly useful to provide higher yields of Kidman reaction products relative to electrolysis products.

Concentrated or intense energy is a means of ionization. Also, intense energy is a means of providing a sufficient amount of light when applied to hydrogen or suitable hydrogen substitute atoms. Intense energy can come from conversion of potential to kinetic energy. A high potential energy field can produce a high energy discharge. For example a glow discharge is produced by AC field reversal on a dielectric material. Chemical reactions can produce a concentration of energy. Several means to produce concentrated energy are called plasma sources. Atomic spectroscopy uses various plasma sources or methods to ionize and atomize samples for analysis. Six of these methods are flame, inductively coupled plasma, direct current plasma, electrothermal, electric arc and electric spark.

One may expect a greater control of an amount of plasma with direct current plasma, AC current plasma or inductive plasma than with an electric arc or an electric spark. One may expect conduction of electrons to disrupt the sequence of chemical/nuclear reactions in the region of the plasma. However, mass and energy flow out of the plasma region will move mass out of electrical immobilization thus allowing the sequence to flow from plasma equilibrium to phat formation to pre-nuclear states to cluster formation. One concludes that a complete sequence of reactions can occur as reactant gases mix in a region that surrounds a plasma state.

Thus, there are various means of ionization and various means of providing light for phat formation. Many means do both ionization and provide light for phat formation. There are also various means to shift the equilibrium by changing energy or mass flow. Therefore, various process flowcharts and modes of operation are possible. One can use a batch mode by changing energy flow or a continuous flow mode by providing for diffusion or convective mass flow. One skilled in the art can envision various modes and reaction schemes to take advantage of any desired step in the sequence of chemical/nuclear reactions. These modes increase as one envisions new products.

### Ramifications of Materials

One skilled in the art envisions new chemical/nuclear products which result from adding new reactants or recycling products to various steps in the sequence of chemical/nuclear reactions. Further, some products of the sequence of chemical/nuclear reactions are themselves capable of nuclear reactions.

Since the ionization energy of oxygen is so close to that of hydrogen, oxygen may be used to generate light at ionization energies which can transfer to the phat photons of the ionization energy of hydrogen. The closeness of the ionization energy of oxygen and hydrogen allow production of pre-nuclear states of oxygen and therefore more ready transfer of w-wave energy to oxygen as a target than other possible target atoms. Therefore, oxygen is among the elements that can substitute for hydrogen isotopes as a reactant to produce pre-nuclear states.

The range of reactants includes other light elements that can substitute for hydrogen isotopes. For example, the elements listed in table 12 have at least one ionization energy value at the same energy value as one of the phats of hydrogen ionization. There should be no expectation that atoms used in composition 1.0 need be mono-atomic or diatomic atoms. Most atoms exist as molecules and molecules can be ionized and atomized. For example, embodiment A uses deuterium gas while embodiment B uses water. The range of reactants extends to molecules. Molecules can be ionized sufficiently to create electrons and ions.

Light is also a reactant. One may use a means to concentrate light or to generate light at the ionization energy of hydrogen or at the energy of any of the phat photons of the ionization energy of hydrogen.

Ramification of Chemical/Nuclear Compositions which can Produce Nuclear Reactions

An embodiment is chemical/nuclear compositions which can produce nuclear reactions. These are chemical/nuclear compositions produced by one or more steps in the sequence of chemical/nuclear changes previously described. Step 3.1 describes a composition that combines photons into higher energy photons. A sufficiently energetic photon can absorb to an atomic nucleus which can cause a radioactive isotope to decay. A sufficiently energetic photon can cause photodisintegration of certain light elements. Thus, photodisintegration makes neutrons for neutron absorption reactions. Step 3.2 describes a transition state between a chemical state and a nuclear state. These transition states are also called pre-nuclear states and can convert to w-wave activated atoms. They are a composition of an electron and an atomic nucleus of a hydrogen atom or of suitable substitutes bound together by at least one non-transverse wave which contains a neutrino or anti-neutrino. A non-transverse wave which contains a neutrino or anti-neutrino is a w-wave. W-waves provide a shielding of charge and therefore atoms in pre-nuclear states used as projectiles can penetrate the coulomb barrier of a target atom at lower kinetic energy than atoms that are not activated by a pre-nuclear state. Because of this shielding, atoms in pre-nuclear states are useful as targets or projectiles in kinetically driven fusion processes. Furthermore, w-wave activated atoms can share w-wave activation with other baryonic elements. The composition of a w-wave activated element is like an un-activated element, but it may also contain non-transverse waves between components of baryons of its nucleus. W-wave activated elements can cause photodisintegration of certain light elements or cause a radioactive isotope to decay. Step 3.3 describes clusters of activated atoms. These clusters are nano-sized nuclear reactors. Clusters are bound together by electrical attraction and by multiple non-transverse waves. Chemical/nuclear compositions in clusters are: atoms in pre-nuclear states, any product of reaction of any atoms in pre-nuclear states, any element(s) activated by mixing those element(s) into the cluster, any product of the reaction of any element(s) activated by mixing element(s) into the cluster and non-transverse wave energy products such as w-waves. A nano-sized nuclear reactor or many of its activated or energetic products can cause any of nuclear reactions described for step 3.2. One expects w-wave activated atoms may separate from a cluster. There are w-wave activated atoms in these clusters and as products from these clusters. Hence, these clusters and w-wave activated atoms produced by these clusters are useful as a targets or projectiles in kinetically driven fusion processes.

Further, several complex nuclear reactions occur in a nano-sized reactor: 1) a reaction caused by absorption of several neutrons to a target atom which causes activation of giant resonance of a target atom such that the target atom can absorb hydrogen isotopes or other light elements rather than just neutrons, 2) a reaction caused by absorption of several neutrons and several hydrogen isotopes which causes activation of giant resonance of a target atom such that the target atom can absorb other such activated target atoms, 3) a reaction caused by w-wave activation of a hydrogen atom or of a suitable substitute of a hydrogen atom or a target atom such that one or more of the activated atom's protons becomes a neutron, and 4) a reaction caused by w-wave activation such that the activated atom can fuse with other atoms at a lower kinetic energy than fusion can occur with non-activated atoms.

Fission processes which depend on radioactive isotopes are likely to be less energetic when altered by w-wave activated atoms. W-waves increase the probability of beta decay by activation of radioactive isotopes. Further, w-waves unfreeze nuclear structure. A frozen object hit with a high energy projectile will fracture but an unfrozen object has energy sufficient to rearrange. Further, the rearrangement by w-waves will accommodate large amounts of energy as seen in the embodiment A example in reference to the dissolution of iron into deuterium atoms. The expectation is a larger number of fission pathways, fewer radioactive products and less energy release per reaction. The author refers the reader to the LENR literature on the range of elements produced and proposed decay pathways for confirmation of this expectation.

In general, the nuclear reactions which occur include: photodisintegration, neutron absorption, accelerated nuclear decay of radioactive isotopes, fusion of elements and some fission of elements. The kind of fusion and/or fission reactions and output products depend on what elements are present, transfer of energy between reactions, and whether or how the cluster is fed reactants from step 3 and/or step 1 or is fed non-excited atoms or recycled atoms or atoms in other streams which were prepared with part of this sequence of activations and reactions.

### Ramifications of Activated Chemical/Nuclear Compositions as Fuels

An embodiment is to produce chemical/nuclear compositions useful as fuel from nuclear reactions. These chemical/nuclear compositions are any activated chemical/nuclear compositions which can be produced by various possible reaction schemes. The means of activation of chemical/nuclear energy is energy storage as w-waves or w-waves may create some other means of exchange of energy between atoms rather than being directly involved in such an exchange of energy. Given that w-waves create some means of exchange of energy rather than being directly involved in such an energy exchange, then that means of exchange is a fuel if it is a composition of matter.

Given that w-wave activated atoms may transfer excitation energy to other atoms, then these other atoms become w-wave activated atoms. When an activated atom decays via a pre-nuclear state, it radiates a photon which is absorbed by the surrounding mass. Thus, mass converts to energy as photons and then photons convert to heat.

One can produce fuels and then one can react fuels in a later step as shown in embodiment B. Fuels are formed by reaction within the nanoreactors. The stability of a fuel as a cluster depends on w-wave equilibrium within the cluster. Relativity predicts that the decay time of a pre-nuclear state is a function of time dilation. A cluster will decay faster with fewer baryon dense atoms. A smaller cluster will decay faster than a larger cluster. Fluid shear is expected to reduce cluster size. Further, dispersion of w-wave energy is expected by mixing clusters with non-w-wave activated atoms and especially non w-wave activated ions.

### Ramifications of Reaction Products

Another embodiment is the de novo production of elements. These are any elements produced by the sequence of chemical/nuclear reactions per FIG. 4.

The composition of the reactants is very useful for controlling the overall reaction. For example, in embodiment A deuterium is a reactant while in embodiment B, the lack of deuterium causes its synthesis from hydrogen to hydrogen fusion. Since the elements listed in table 8 are expected to become w-wave activated, then new reactions are expected with these elements. Since radioactive isotopes are expected to experience accelerated decay rates, it follows that when they are used as reactants, new reactions will be expected. As indicated earlier the common LENR experiment constructs a waveguide and then the material of the waveguide reacts with the NAE. Such a reaction will depend on the materials of construction and whether hydrogen or a substitute for hydrogen is used. The LENR literature suggests a wide range of elements can be produced with a NAE. Some of these are produced by fusion and some by fission of fusion products.

In general, the kind of fusion reactions and output products depend on many factors: 1) what elements are present, 2) the transfer of energy between reactions, 3) whether or how the cluster is fed reactants 5) whether or how the cluster is dispersed, 6) whether the cluster size is maintained or increased by feeds of phats or W-activated atoms or 7) whether the cluster size is reduced or dispersed by feeds of non-excited atoms. Atoms may be recycled from prior reactions or fed in from other reaction schemes. Feed streams may be prepared for feed by use of part or all of the sequence of activations and reactions. Further, one can direct fusion of light elements by mixing. One expects to control outputs based on concentrations of reactants.

While the above description contains many specificities, these should not be construed as limitations of the scope of any embodiment, but as exemplifications of various embodiments thereof. Many other ramifications and variations are possible within the teachings of the various embodiments. For example, further ramifications are improvements of embodied nuclear processes or products of the embodied nuclear processes are expected by applying principles of chemical reaction engineering to any of the aforementioned embodiments or ramifications based on reaction steps, reaction equations, and kinetic information.

Thus the scope should be determined by the appended claims and their equivalents, and not by the examples.

1. A method to produce nuclear reactions and a method for de novo synthesis of elements and a method for producing chemical/nuclear compositions that in turn produce nuclear reactions and a method for producing chemical/nuclear compositions that have fuel value, comprising:
a. creating a composition 1.0 of atoms for reaction of suitable concentration where this composition consists of atoms of hydrogen and/or of suitable substitutes for hydrogen atoms and if desired other target atoms,
b. combining composition 1.0 with a means for ionization 2.1 of atoms of hydrogen and/or of suitable substitutes for hydrogen atoms where the ionization is sufficient to create electrons and ions, and with a means to provide an amount of light 2.2 at the ionization energy of hydrogen and/or at the ionization energy of suitable substitutes for hydrogen where the amount of light is sufficient to create quantum states between electrons and ions and for a time period sufficient to energize these quantum states,
c. applying a means to shift mass equilibrium toward a condensation of atoms which shift results in step 3.1 and leads to more steps in a sequence of chemical/nuclear changes which steps in this sequence of changes are:
step 3.1 producing compositions that combine photons into higher energy photons,
step 3.2 producing transition states between a chemical state and a nuclear state of hydrogen atoms and/or of suitable substitutes of hydrogen atoms,
step 3.3 recombining atoms with said transition states of hydrogen atoms and/or of suitable substitutes of hydrogen atoms in a form of a cluster and
step 3.4 reacting of atoms of hydrogen and/or suitable substitutes for hydrogen atoms with each other and/or if desired with other target element(s) mixed with the cluster to produce de novo synthesis of elements and/or new chemical/nuclear compositions
whereby said method produces nuclear reactions and whereby said method produces a cluster of energetic atoms wherein atoms of said cluster and/or atoms introduced into said cluster react by various nuclear reactions to produce de novo synthesis of elements and whereby said method produces said chemical/nuclear compositions that in turn produce nuclear reactions and whereby said method produces said chemical/nuclear compositions that have fuel value.

2. The methods of claim 1 wherein a desired nuclear reaction is activation of a giant resonance in the target atom whereby a radioactive target atom would have an accelerated rate of nuclear decay.

3. The methods of claim 1 wherein said suitable substitutes for hydrogen atoms include but are not limited to isotopes of hydrogen, helium, lithium, beryllium, boron, carbon, nitrogen, oxygen and indium.

4. The methods of claim 1 wherein atomic composition 1.0 is used as a means for increasing the rate of fusion with oxygen relative to combustion with oxygen based on reaction order and reaction equations.

5. The methods of claim 1 wherein the intensity of energy supplied to a means for ionization 2.1 is used as a means for increasing the rate of fusion with oxygen relative to combustion with oxygen based on reaction order and reaction equations.

6. The methods of claim 1 wherein said means for ionization and said means to provide an amount of light are provided by a means for plasma generation which include but is not limited to: flame or other chemical reaction, inductively coupled plasma, direct current plasma, electrothermal, electric arc and electric spark.

7. The methods of claim 1 wherein the means to provide an amount of light or the means to provide ionization is a waveguide or any other construction of the surrounding media constructed in such a way as to use the material or electromagnetic properties to concentrate the flow of energy in an active region which active region may include transient cavitation bubbles or which active region may include an electrode surface.

8. A method of claim 7 wherein the means to provide an amount of light or the means to provide ionization concentrates light at the ionization energy of hydrogen and/or one of its phats and/or at the ionization energy of a suitable substitute of hydrogen and/or one of their phats.

9. The methods of claim 1 wherein the means to shift mass equilibrium toward a condensation of atoms is energy transfer out of an active region.

10. The methods of claim 1 wherein the means to shift mass equilibrium toward a condensation of atoms is to transfer reactant masses out of an active region.

11. The methods of claim 1 wherein the transfer of reactant masses also mixes reactants such that said steps 3.2 through 3.4 occur faster and/or more frequently.

12. The method of claim 10 wherein said reactant masses are in a gaseous state to improve the rate of mass transfer.

13. The methods of claim 1 wherein mixing is used to control the size of nanoreactors and especially where such control of the size of nanoreactors reduces the amount of competing endothermic reactions.

14. The method of claim 10 wherein the yield of fuel per unit volume is increase by recycling the product from claim 10 to the beginning of the process and adding more target atoms to replace target atoms consumed according to stoichiometry of reaction observed in previous cycles.

15. Chemical/nuclear compositions that have fuel value and/or chemical/nuclear compositions that in turn produce nuclear reactions, comprising any of the following:
a) a composition of electrons and ions of hydrogen atoms and/or of suitable substitutes that combine photons into higher energy photons,
b) a composition which is bound together by a non-transverse wave which non-transverse wave contains a neutrino or anti-neutrino and produces a dipole which binding is between an electron and an atomic nucleus of a hydrogen atom and/or between an electron and a suitable substitute of a hydrogen atom,
c) a composition of electrons and atomic nuclei of hydrogen atoms and/or of suitable substitutes of a hydrogen atoms bound together by electrical attractions and by multiple non-transverse waves into the form of a cluster wherein said cluster may also contain products from nuclear reactions within said cluster,
d) a composition of electrons and atomic nuclei of hydrogen atoms and/or of suitable substitutes of a hydrogen atoms bound together by electrical attraction and by multiple non-transverse waves into the form of a cluster wherein other target element(s) may be mixed with the cluster to produce de novo synthesis of elements and/or new chemical/nuclear compositions also wherein said cluster may also contain products from nuclear reactions within said cluster,
e) elements activated by non-transverse waves within their nuclei wherein said nuclei contain baryons,
whereby said chemical/nuclear compositions will be provided that can release energy by decay of their excited states and/or whereby said chemical/nuclear compositions can cause reactions which can release energy and/or whereby said chemical/nuclear compositions will be provided that will transfer sufficient energy to atomic nuclei to produce nuclear reactions and/or whereby said chemical/nuclear compositions will be provided that, because of their very short dipole, will penetrate a coulomb barrier to atomic nucleus at much less kinetic energy than chemical/nuclear compositions without said dipole and/or whereby components of said chemical/nuclear compositions will condense to neutrons.

16. The chemical/nuclear compositions of claim 15 wherein said suitable substitutes for hydrogen atoms include but are not limited to isotopes of hydrogen, helium, lithium, beryllium, boron, carbon, nitrogen, oxygen and indium.

17. The chemical/nuclear compositions of claim 15 wherein the chemical/nuclear compositions are used as reactants for kinetically driven nuclear processes.

18. The chemical/nuclear compositions of claim 15 wherein the chemical/nuclear compositions are used to produce reactants for nuclear processes.

19. The chemical/nuclear compositions of claim 15 wherein other atoms are mixed with the chemical/nuclear compositions in order to transfer excitation energy to said other atoms and to make of such other atoms fuels from which energy can be extracted faster than their parent chemical/nuclear compositions.

20. The chemical/nuclear compositions of claim 15 wherein the rate of heat production from fuels is increased by any of the following: elevating the fuel temperature, mechanically mixing fuels with atoms that are less stable to w-waves in order to increase the concentration of w-activated atoms that are less stable to w-waves and/or providing an energy input and/or material input which increases concentration of ions.
